(19) United States
(12) Patent Application Publication
(10) Pub. No.: US 2017/0023693 A1
(43) Pub. Date: Jan. 26, 2017

(54) AIRBORNE PLATFORM FOR AIRCRAFT WITH ATTITUDE CORRECTION AND TOW HITCH ASSEMBLY

(71) Applicant: ACTION COMMUNICATION, Cuers (FR)

(72) Inventor: Alexis GIORDANA, Pierrefeu (FR)

(21) Appl. No.: 15/287,326

(22) Filed: Oct. 6, 2016

Related U.S. Application Data
(63) Continuation of application No. 15/247,276, filed on Aug. 25, 2016.
Application No. 15/247,276 is a continuation of application No. PCT/FR2014/050452, filed on Feb. 28, 2014.

(51) Int. Cl. G01V 3/16; G01V 3/17; B64D 3/00

(52) U.S. Cl. CPC G01V 3/16; B64D 3/00; G01V 3/17

(57) ABSTRACT

In a general aspect, an airborne geophysical prospection device can include a support structure having a surface area of several hundred square meters and an electromagnetic antenna disposed on the support structure. The electromagnetic antenna can have a surface area of several hundred square meters. The electromagnetic antenna can include one or more loops disposed on the support structure. The support structure can be configured to be towed behind an aircraft with a towing cable. The support structure can be supple, deployable under traction and substantially planar after deployment.

### CROSS REFERENCE TO RELATED APPLICATIONS

This application is a continuation of U.S. application Ser. No. 15/247,276, filed Aug. 25, 2016, which claims priority to and is a continuation of PCT Application No. PCT/FR2014/050452, filed Feb. 28, 2014, the disclosures of which are both incorporated herein by reference in their entirety.

### TECHNICAL FIELD

The present disclosure relates to an airborne platform or, more generally, to a towed device for an aircraft, pulled by the latter through a towing cable. More particularly, this disclosure relates to towed devices that include a measurement element support structure for collecting valuable information in the fields of prospecting for natural resources or even identifying underground voids.

### BACKGROUND

The field of geophysical mapping is currently expanding rapidly in order to gain a better understanding of the evolution of the underground environment, notably hydrology. Finding water in desert regions in particular is a growing concern. Such discoveries for example include detection or identification of karstic networks.

The same is true of the search for mineral resources situated at medium depths, namely at depths of less than 300 meters, or even for identifying oil or gas deposits.

Other requirements have more recently become the subject of research in the field of mapping. Such requirements relate, for example, to the detection of underground voids for storing resources or even waste.

In order to deliver geophysical mapping data, one technique, according to a principle that is highly simplified, is to measure the vertical and horizontal variations in the electrical resistivity of the subsoil. For this purpose, an airborne emitting antenna is used, such as a loop or a coil, to emit electrical pulses toward the ground, more specifically the subsoil that is to be studied. A primary magnetic field is therefore created. A sudden breach in the primary magnetic field generates eddy currents having an intensity that increases with increased conductivity of the formations present in the subsoil. These induced currents in turn create a secondary magnetic field. This field is measured by a receiving antenna, such as a coil or a loop, and then analyzed in order to determine the resistivity of the formations.

In order to convey such measurement element on site, certain constructors or operators have fitted airplanes with electromagnetic antennas that encircle the airplanes. Such an antenna can include one or more loops emitting and/or receiving electromagnetic waves. The antenna is constructed by leading an electrical conductor from the front of the aircraft, through an extension means maintaining the conductor at a distance from the cockpit, thus extending the perimeter of the antenna to the tips of the wings and to the rear of the fuselage of the craft. Thus, the antenna essentially has the appearance of a rhombus with the diagonals defined by the wings and the fuselage of the aircraft. It is therefore necessary to use airplanes that have a large wing span in order to carry an antenna that is large enough to collect terrain information, for example a four-engine airplane of the Bombardier Dash-7 type. Because the attitude of the antenna is substantially that of the airplane carrying it, it is necessary—unless complex calculations are used in order to take the angle of incidence of the antenna with respect to the ground into consideration to keep the craft perfectly level when collecting data. In order to maintain such a substantially horizontal attitude, an airplane needs to travel at a relatively high speed. Below that speed, the craft has a steep angle of incidence, namely flies “nose-up” as in a landing configuration. Now, a high speed has an adverse effect on the quality of the measurements taken. Moreover, the electrical conductor or conductors that form an antenna encircling the airplane deform during flight, flapping or even creating movements and/or vibrations that make the airplane unpleasant or even dangerous to fly, to the extent of forcing an unscheduled or emergency landing. Furthermore, having to resort to a large-sized airplane leads to high operating and maintenance costs, which costs are also exacerbated by the complex and lengthy assembly procedure of the antenna that encircles the craft.

In an attempt to circumvent these disadvantages, an antenna that is substantially circular, or at least piecewise circular, has been designed to be helicopter-borne, and thus conveyed on site by a helicopter. The resulting surface area of such an antenna can be clearly greater than that of an antenna that encircles an airplane, because the dimensions of the antenna are no longer directly dependent on those of the aircraft. It thus becomes possible to construct one or more concentric and coplanar antennas that cooperate with the distal ends of a plurality of stays of substantially the same length, the proximal ends of which are joined together and connected to a winch of a helicopter, then carry the structure thus constructed. One or more electrical cables connect the antenna to a computer carried onboard the craft. Because the circumference of the antenna is greater, the scanning of a site is thus optimized, requiring fewer passes than with an airplane encircled by an antenna. Furthermore, the measurements can be collected at a low speed. However, such a solution does raise numerous disadvantages that adversely affect the quality of the processing performed on the measurements collected and that keep the operating and maintenance costs high. Specifically, mounting such a structure remains a complex process and requires a vast assembly area. A helicopter also has a lower range compared to an airplane, while at the same time having a high fuel consumption. Scanning a large site thus remains a painstaking and imperfect process. Moreover, a major disadvantage lies in the fact that the “antenna(s) with stay(s)” structure tends to swing, the repeated and unpredictable oscillations of which cause the attitude of the measurement device to fluctuate. In an attempt to correct or reduce the inevitable swing phenomenon in the processing of the collected measurements, a plurality of sensors is generally positioned along the circumference of the borne structure. However, despite increased processing complexity, the data or maps resulting from the processing of the collected measurements may prove to be unreliable and unusable.

Moreover, the electromagnetic waves reflected and picked up by a receiving antenna carried by the aircraft, in the form of a circled airplane or of a helicopter, reflect again off the stays or off the fuselage, off the wing structure or the rotor blades depending on the aircraft used. These subsequent reflections have a strong adverse impact on the relevance of the measurements collected.

No effective and economic solution currently exists that allows airborne conveying of a large-circumference antenna, e.g., having a surface area greater than several hundred, or even several thousand square meters, with a stable and determined attitude.

The implementations disclosed herein address most of the disadvantages found in the known solutions.

### SUMMARY

Taking its inspiration from the technique of towing advertising banners by small airplanes, which are light and economical, especially in comparison with planes encircled by electromagnetic loops, the implementations disclosed herein relate to a structure including an aircraft, a towing cable and a towed device, the aircraft pulling the towed device through said towing cable.

The techniques of attaching an advertising banner after take-off of a light airplane are fully mastered. However, the dimensions, generally a few tens of square meters, of an advertising banner are very much smaller than those of a support structure for an antenna intended to collect geophysical data. Moreover, an advertising banner is towed in a substantially vertical plane that may potentially fluctuate during flight. To date, such technical teaching has never been considered for use in the field of airborne measurement collection. This teaching is in fact not recognized, or is even considered to be unsuitable and unusable as such for towing a large-sized antenna which, furthermore, is to maintain a stable, in particular horizontal attitude during the measurement campaign. The implementations disclosed herein make it possible to overcome these prejudices by providing the towing attachment with an automatic attitude-correcting structure and with specific and particularly well matched male and female in-flight attachment elements. An electrical connection between the towed measurement element and the aircraft can also be achieved through the in-flight attachment elements.

Among the numerous advantages afforded by the disclosed implementations, the following may be mentioned:

an antenna of very large dimensions, for example measuring several hundreds or thousands of square meters, may be attached to a light airplane after the airplane has taken off;

a towed device, an antenna or, more generally, any measurement sensor carried by the towed device may be coupled automatically during in-flight attachment to a computer carried onboard the towing aircraft;

one or more measurement sensors may be arranged very simply on a support structure that is readily packaged and deployed, thus greatly limiting the assembly and handling costs of a towed device according to the implementations disclosed herein, e.g., ten to twenty times less expensive than prior art procedures in terms of the required hardware and personnel;

a towed device, and therefore potentially any measurement sensor carried by the device, may be connected electrically and automatically to a computer carried onboard the aircraft as soon as the towed device according to the disclosed implementations is attached to a towing cable pulled by an aircraft in flight;

a towed device having a substantially vertical attitude, for example an advertising banner, may be connected electrically to an aircraft to control a display or for collecting measurements delivered by sensors present on the towed device, especially in view of hydrological prospecting;

a light aircraft may be preferable, which is economical in terms of energy consumption and has a large radius of action, so as to minimize the time taken to scan a site while at the same time minimizing the costs of such a mission;

valuable high-precision measurements may be collected by an electromagnetic loop maintained vertically near a cliff when performing hydrogeological prospecting, for example, or even for modeling rock falls;

valuable high-precision measurements may be collected with an electromagnetic loop maintained horizontally, for example when prospecting for natural resources or even identifying underground voids;

any alteration of the raw data collected, or any complex calculation for correcting a fluctuating attitude of the prior art measurement sensors may be avoided by virtue of the action of an attitude-correcting structure of a towed device according to the disclosed implementations;

any negative influence that the aircraft has on the data collected by a towed device according to the disclosed implementations may be avoided by virtue of the fact that the measurement sensor or sensors, in particular antennas emitting and receiving electromagnetic waves, are kept away from the aircraft, the latter pulling the towed device several tens of meters behind it;

one of the major disadvantages of the known solutions, wherein a carrier aircraft interacts or interferes with an airborne antenna, thus adversely affecting the multiple-measurement capacity of the aircraft and therefore entailing a plurality of passes of aircraft equipped with distinct sensors, may be avoided by allowing a plurality of sensors to be carried simultaneously by the towed device, thereby increasing the quality, quantity and variety of measurements collected during a single flight, thus scaling down the itineraries of the towing aircraft and therefore decreasing the duration and cost of a mission involving scanning a site of interest.

To that end, the disclosed implementations relate to a towed device including:

a female attachment element designed to cooperate with a male attachment element of a distal end of a towing cable for an aircraft,

a traction pole linked to the female attachment element,

a supple support structure that is substantially planar when deployed, the support structure comprising a fastening element cooperating with the traction pole.

In order to carry out geophysical measurement campaigns in particular or, more generally, to automatically control the attitude of the towed support structure, such a towed device can further include an attitude-correcting structure positioned between the female attachment element and the traction pole, the attitude-correcting structure automatically keeping the support structure in a determined attitude when the towed device is being pulled by an aircraft.

When a device according to the disclosed implementations is to be used for taking geophysical measurements along rocky surfaces or even for conducting advertising campaigns, the determined attitude may be substantially vertical. In such cases, the attitude-correcting structure may be included in a correction pole, linked to the traction pole by means of a plurality of coplanar traction stays having respective proximal ends attaching to the correction pole and respective distal ends attaching to the traction pole, the respective lengths of the traction stays and their respective attachment points to the poles being axially symmetric with respect to a midline common to the poles.

As an alternative, in particular for carrying horizontal measurement sensors, the determined attitude of the support structure may be substantially horizontal. The attitude-correcting structure may then advantageously include a correction pole each end of which cooperates with:

the two ends of the traction pole through first traction stays of a same first length,

the central part of the traction pole through second traction stays of a same second length.

Whatever the determined attitude, the attitude-correcting structure may be arranged in such a way that the correction pole links to the female attachment element through attachment stays having distal ends attaching to the correction pole, the proximal ends of the stays being joined together and attaching together to the distal end of an attachment cable having a proximal end linked to the female attachment element.

The attitude-correcting structure according to the disclosed implementations may further allow adjustment of the relative elevation of the support structure with respect to that of the towing cable. For example, the individual lengths of the attachment stays may be determined mutually such that the correction pole is automatically positioned vertically and then kept vertical when the towed device is being towed by an aircraft. Moreover, the individual lengths of the attachment stays may furthermore be determined to define a relative elevation of the longitudinal axis of the support structure with respect to that of the distal part of the attachment cable.

To ease assembly and maintenance of a towed device according to the disclosed implementations, the correction pole may include a hollow tubular structure that includes openings. The attachment stays may also be included in a same line linked to the correction pole through the openings, the individual lengths of the attachment stays formed in this way being determined by knotting the line or by travel-limiting elements. The traction pole may also include a hollow tubular structure including openings. The traction stays may therefore be included in the same line attached to the poles through the openings, the individual lengths of the traction stays formed in this way being determined by knotting the line or by travel-limiting elements.

To favor a flat attitude and suppress flapping of the support structure during flight, the support structure may include a micro-perforated aerodynamic damping fabric. The support structure may further include damping elements positioned opposite the traction pole, the damping elements having a micro-perforated structure.

In order to conduct measurement campaigns, for example geophysical measurement campaigns, the support structure may carry a measurement element including an antenna in the form of one or more loops designed to emit electromagnetic signals. The support structure may further carry a measurement element including one or more sensors or probes.

In order to provide a wired electrical communication between the towing aircraft and a measurement element carried by the towed device, the measurement element may be connected to a wired communications bus whose proximal end cooperates with the female attachment element in the form of one or more electrical connectors.

To collect measurements with the towed device, the support structure may carry an antenna for receiving electromagnetic signals. As an alternative or in addition, the attitude-correcting structure may carry an antenna for receiving electromagnetic signals.

To provide electrical communication between the aircraft and an antenna for receiving electromagnetic signals, where the antenna is carried by the towed device, the latter may be connected to a wired communications bus whose proximal end can include one or more electrical connectors and cooperates with the female attachment element.

In order to carry such a wired communications bus, the attachment cable may encircle the proximal end of the communications bus. As an alternative, the attachment cable may include a fibrous structure, the proximal end of the communications bus being braided with the fibers of the cable.

In order to attach the towed device with a hook of a towing cable, the female attachment element may have a hollow conical structure. The external wall of the conical structure of the female attachment element may further include a sleeve designed to accept the end or head of the proximal end of the attachment cable, the proximal end being arranged in the form of a closed loop.

As an alternative, the female attachment element may include a V-shaped member having two plates and a sleeve designed to accept the end or head of the proximal end of the attachment cable, the proximal end being arranged in the form of a closed loop, and the plates being attached to the sleeve.

In order to provide an electrical connection, electrical connectors may protrude from the internal walls of the plates of the V-shaped member, the latter being dielectric.

In addition, the female attachment element may further include an element for attaching a tension cable.

As an alternative or in addition, the female attachment element may include electrical connectors protruding from the internal wall of the conical structure, the latter being dielectric.

In order to use a towed device according to the disclosed implementations, a towing cable is provided herein for an aircraft, having a distal end comprising a male attachment element having a stud designed to cooperate with the female attachment element of the towed device.

In order to ensure electrical communication between the aircraft and a towed device according to the disclosed implementations, the stud may be conical, comprising electrical connectors protruding from the dielectric external wall of the cone, wherein the electrical connectors are included in the distal end of a communications bus carried by the towing cable. The electrical connectors may include separate concentric rings.

According to a second implementation, the male towing cable attachment element according to the disclosed implementations may further include a hook movably mounted on the distal end of the towing cable. A heel may be fixedly mounted at the distal end of the towing cable. With such an arrangement, the stud may be a V-shaped member comprising two plates, the vertex of which is attached to the hook so that the heel can slide within the member under the traction of the towing cable until it comes to bear against the internal vertex of the member.

According to a third implementation, the male attachment element may include a hook movably mounted on the distal end of the towing cable and a heel mounted fixedly at the distal end of the towing cable. The stud may include a V-shaped member comprising two plates, the external vertex of which forms the hook, so that the heel can slide within the member under the traction of the towing cable until it comes to bear against the internal vertex of the member.

According to these last two implementations, in order to achieve an electrical connection, the member may include electrical connectors protruding from the dielectric external wall of the plates of the member, wherein the electrical connectors are included in the distal end of a communications bus carried by the towing cable.

In order to prevent any risk of mechanical or electrical failure during the phase of attaching a towed device to an aircraft, the male attachment element of a towing cable according to the disclosed implementations may include an attachment damper. This element absorbs some of the traction force of the towing cable as the mating attachment elements of the towed device and of the towing cable engage with one another.

Such an attachment damper may include a pneumatic or hydraulic actuator having a cylinder mounted fixedly on the heel of the male attachment element according to the second and third implementations. The piston may then be mounted fixedly on the hook of the male attachment element.

In order to control and/or regulate the shock-absorbing capacity of the actuator and reduce the weight of the towed device in flight, the cylinder of the actuator may be prefilled with a fluid. The cylinder may further include one or more openings through which the compressed fluid is expelled under the action of the piston.

The disclosed implementations moreover relate to any towed structure comprising an aircraft, a towing cable and a towed device, wherein the aircraft pulls the towed device through said towing cable, the male attachment element of the towing cable cooperates with the female attachment element of the towed device, and the male and female attachment elements are in accordance with the disclosed implementations.

The aircraft may further include a computer for generating and interpreting electromagnetic signals, the signals being conveyed by the communications bus, and emitted and received by a measurement element carried by the towed device.

The disclosed implementations further relate to a specific attachment area allowing a towed device according to the disclosed implementations to be attached in-flight to an aircraft. When the proximal end of an attachment cable of the towed device forms a closed loop whose head connects to the female attachment element of the towed device, such an attachment area can include three posts positioned in a triangle. The two posts forming the base of the triangle can include attachments or guides for receiving respective strands of the proximal part of the attachment cable. The post at the vertex of the triangle then receives the proximal end of the traction cable.

### BRIEF DESCRIPTION OF THE DRAWINGS

Other features and advantages will become more clearly apparent from reading the following description which relates to exemplary implementations given by way of non-limiting indication and from studying the accompanying figures among which:

FIGS. 1a and 1b describe an aircraft using a towing cable to pull a towed device according to the disclosed implementations with horizontal and vertical attitudes, respectively;

FIG. 2 depicts a towed device according to an implementation, designed to have a substantially horizontal stable attitude during flight;

FIGS. 3a and 3b respectively show the attitude-correcting structure of a device according to an implementation in the takeoff phase and then in flight, the attitude-correcting structure being designed to maintain a substantially horizontal attitude during the measurement campaign;

FIG. 3c depicts a simplified side view of a towed device according to an implementation having a horizontal attitude;

FIG. 4 depicts a towed device according to an implementation comprising an attitude-correcting structure to keep the support structure of the device vertical;

FIG. 5 depicts an attachment area for a towed device according to an implementation;

FIGS. 6a and 6b depict a first implementation of a female attachment element of a towed device according to an implementation, in a view from above and from beneath respectively;

FIG. 6c depicts a second implementation of a female attachment element of a towed device according to an implementation;

FIGS. 7a and 7b depict a first implementation of a male attachment element of a towing cable according to an implementation;

FIGS. 7c and 7d depict an alternative form of the first implementation of the male attachment element of a towing cable according to an implementation, the male attachment element comprising an attachment damper and being designed to cooperate with a female attachment element as shown by way of example in FIGS. 6a and 6b;

FIG. 7e depicts a second implementation of a male attachment element of a towing cable according to an implementation, the male attachment element comprising an attachment damper and being designed to mate with a female attachment element as shown by way of example in FIG. 6c; and

FIG. 8 illustrates cooperation between male and female attachment elements after a towed device has been attached to a towing cable according to an implementation.

### DETAILED DESCRIPTION

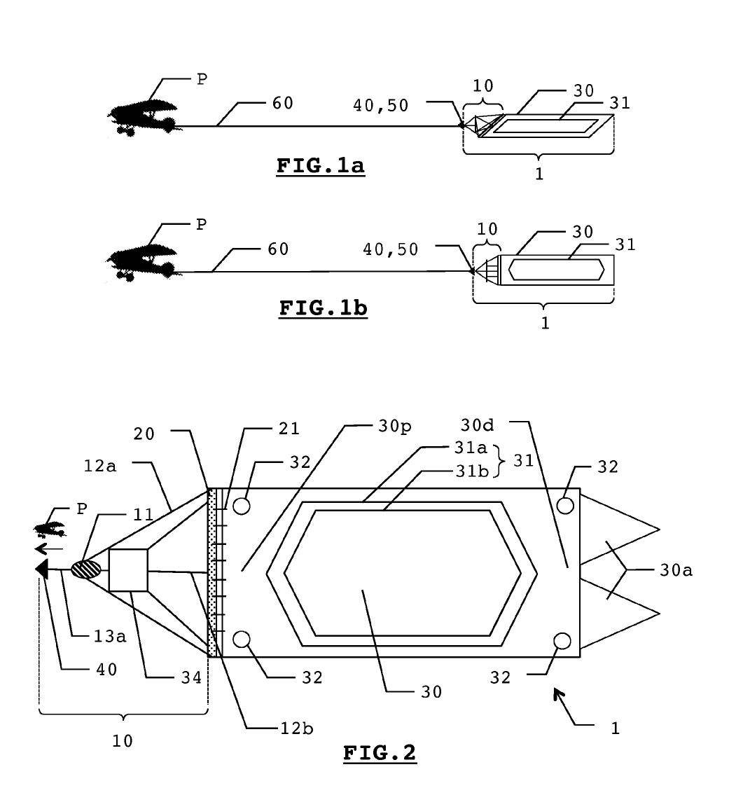

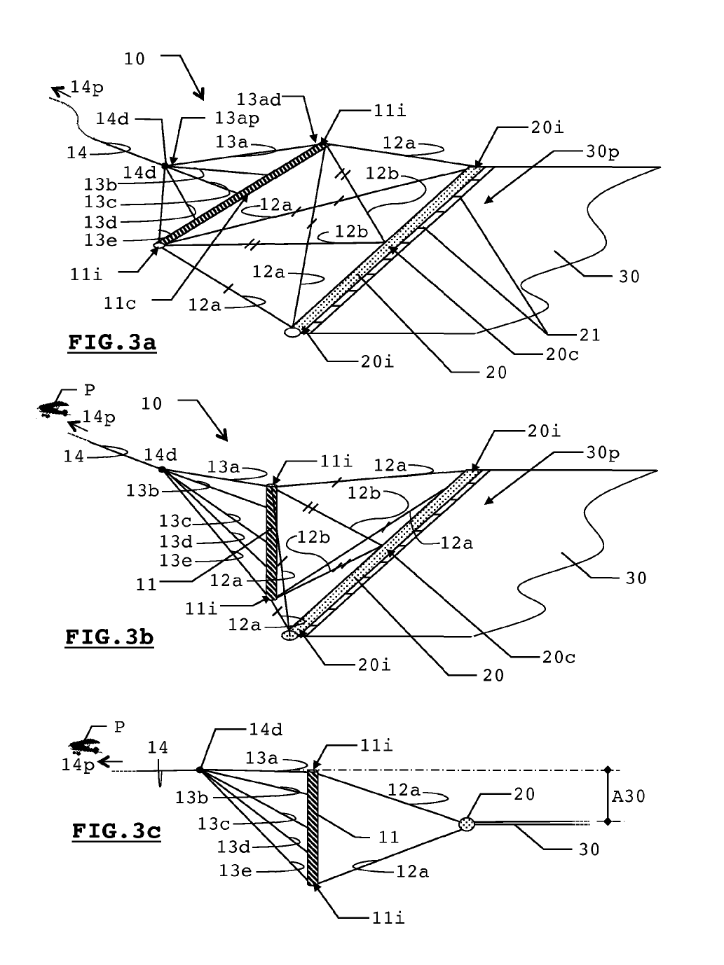

FIG. 1a is a simplified depiction of a towed structure according to an implementation, wherein an aircraft P, for example an airplane configured to tow an advertising banner, pulls, through a towing cable 60 several tens of meters long, a towed device 1 according to a first implementation. Such a device can include a support structure 30 which is substantially flat after deployment, carrying a measurement sensor 31, for example an antenna that emits electromagnetic waves. In order to collect relevant geophysical measurements, such a towed device 1 can include an attitude-correcting structure 10 designed to keep the support structure 30 in a substantially constant and horizontal attitude. Such a structure 10 will be described in greater detail according to an implementation in conjunction with FIGS. 3a to 3c.

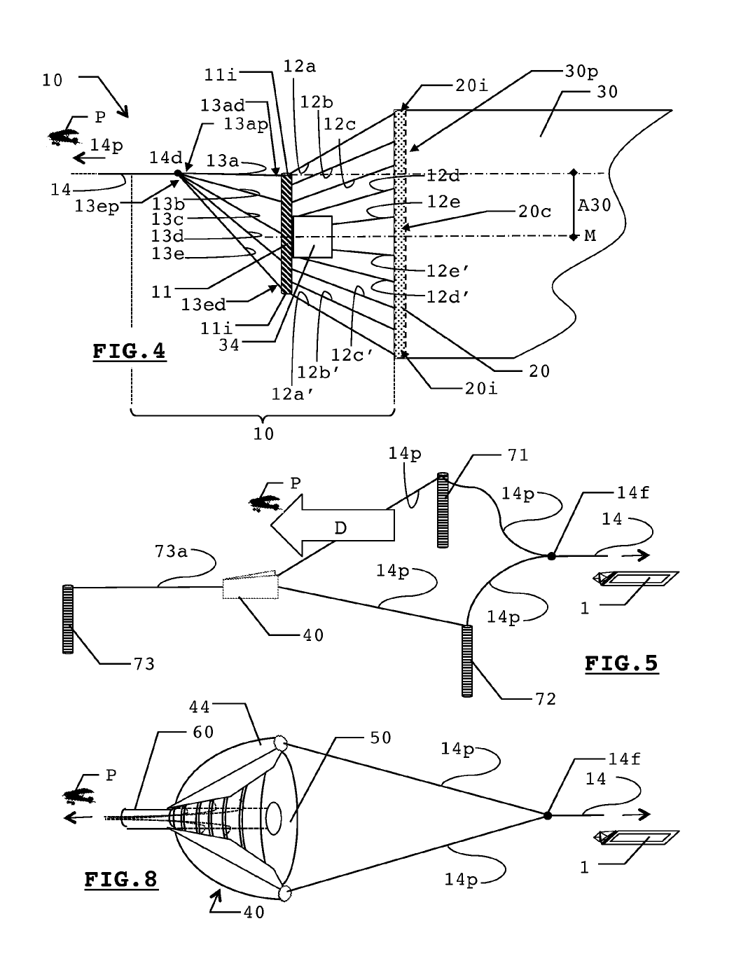

Likewise, FIG. 1b is a simplified depiction of a towed structure according to an implementation, for which an aircraft P, such as an airplane configured to tow an advertising banner, pulls, through a towing cable 60 several tens of meters long, a towed device 1 according to a second implementation. Similarly to the previous towed device, the device according to FIG. 1b can include a support structure 30 that is substantially flat after deployment, carrying a measurement sensor 31, for example an antenna emitting electromagnetic waves. In order to collect relevant geophysical measurements along a cliff, for example, such a towed device 1 can include an attitude-correcting structure 10 designed to keep the support structure 30 in a substantially constant and vertical attitude. Such element 10 will be described in greater detail according to an implementation in conjunction with FIG. 4.

These two implementations of a towed structure can prevent any interactions or impact of the aircraft P on the measurements collected by the measurement element 31 present on the support structure 30, because the support structure is towed several tens of meters behind the aircraft.

FIG. 2 is a more detailed view of a towed device 1 according to an implementation.

The towed device can include a female attachment element 40 designed to mate with a male attachment element (or hook) of a distal end of a towing cable for an aircraft, which has not been depicted in FIG. 2.

Such a towed device 1 can include a compliant support structure 30 which is substantially flat when deployed. The structure 30 may be included a fabric, or even an assembly of fabrics, which may be micro-perforated. This type of material is in particular used to form the main body of certain towed advertising banners. Bearing in mind the surface area of the support structure 30 being towed, which may be as much as several hundreds of square meters, such a fabric may be selected to have a certain number of characteristics, among which, non-exhaustively, a high resistance to tearing and a structure configured to suppress flapping of the support structure 30 during flight. Preferably, a fabric having an aerodynamic damping function may be used. The configuration of the support structure 30 which is described hereinafter is substantially that of a quadrilateral, specifically a rectangle. However, the structure 30 could equally well have other flat geometric shapes, such as a disk, a triangle, etc.

Referring to FIG. 2, the support structure 30 form a flat rectangle, with a length of 40 to 60 meters and a width of 15 to 25 meters, the proximal portion 30p of which is attached to a traction pole 20. The length of the traction pole is substantially the width of the leading edge of the proximal portion 30p of the support structure 30. By way of example, the proximal portion may comprise a series of openings, which can be reinforced, for example, by metal eyelets. The traction pole 20 may be a hollow cylindrical structure, which can have an ovoid cross section, which is biconvex and symmetrical so as to exhibit a tapered trailing edge. The trailing edge may comprise openings aligned with the openings in the proximal portion of the support structure 30c. Fasteners 21, such as cords or cables, anchor the traction pole to the proximal portion 30p of the support structure 30. As an alternative, the traction pole may be solid and comprise protruding rings into which the fasteners engage. The attachment element 21 may further include a same line lacing the openings in the traction pole to the openings in the proximal portion 30p of the support structure. According to a third implementation, the proximal portion 30p of the support structure can include a sleeve designed to take the traction pole 20. Any other link between the traction pole and the proximal portion of the support structure 30 may be envisioned. When the towed device is stored or packaged, the support structure 30 may be rolled, folded, furled in order to reduce volume. In the event where the support structure 30 has a proximal portion 30p with a curved or V-shaped leading edge, the traction pole 20 may have a shape that is likewise curved or V-shaped. As an alternative, the traction pole may remain substantially in the form of a rectilinear cylinder. In that case, the fasteners 21 provide a connection between the support structure 30 and the traction pole 20 such that the longitudinal axis of the support structure 30 coincides with the midline of the traction pole 20.

In order to keep the towed device 1 at a stable and predetermined attitude after the towed device has been attached to an aircraft through an attachment cable provided with a hook, corresponding to the male attachment element, this towed device may comprise an attitude-correcting structure 10 linked to the traction pole 20 and interposed with the female attachment element 40. The structure of such an attitude-correcting structure will be examined in greater detail, in particular in conjunction with FIGS. 3a to 3c and 4. The correcting structure 10 may comprise a substantially cylindrical correction pole lithe structure of which may be identical or similar to that of the traction pole. The attitude-correcting structure 10 is linked through a cable connection to the traction pole 20 by means of a plurality of traction stays 12a, 12b. The correction pole 11 itself may be linked to the female attachment element 40 by a cable connection of one or more attachment stays 13a. According to the example described in conjunction with FIG. 2, an antenna receiving electromagnetic waves may be positioned within the mesh structure of the traction stays 12a and 12b. This antenna may also be attached to the correcting structure 10 by any other means. It could, as an alternative, be carried by the support structure 30 like the antenna 31. The support structure may moreover carry a plurality of emitting and/or receiving antennas 31a, 31b or even other measurement sensors 32, such as altimeters or radioaltimeters to complete a measurement campaign. The sensors 31, 32 may be fixed by any means to the upper and lower faces of the support structure 30, for example by stitching, bonding, crimping, etc. An antenna 31 may also be the result of conducting fibers woven amongst non-conducting fibers forming the support structure 30. The antenna may alternatively be formed of one or more strips of conducting metal, such as aluminum, bonded to the support structure 30. Such strips, which can have a small (thin, etc.) thickness, can reduce the weight of the structure.

According to FIG. 2, the support structure 30, more specifically the distal end 30d thereof, may bear one or more tails 30a, for example in the form of one or more triangles. These tails 30a may be fixed to the distal end 30d by any means such as stitches or fasteners. As an alternative, the distal end of the support structure 30 and the tails may include a single element. Preferably, a tail 30a may comprise or include one or more micro-perforated fabrics or any other material that has aerodynamic damping characteristics. The towed device flaps less under the action of a tail 30a. According to an implementation, the main fabric from which the support structure 30 is made is particularly lightweight. It may have a mass per surface area of the order of 50 g/m2 to 80 g/m2. It may further be micro-perforated with perforations of the order of 0.20 mm to 0.40 mm. A similar fabric configuration may be used for the tails 30a. The mass per surface area thereof may be similar to that of the main fabric. The fabric may be micro-perforated with perforations of the order of 0.30 mm to 0.50 mm, for example. The weight of a towed device is particularly low in relation to its size. This offers a margin of safety, especially when overflying populated regions, and does not in any way compromise the flight capabilities of the aircraft.

FIGS. 3a, 3b and 3c illustrate in more detail an implementation of an attitude-correcting structure 10 of a towed device according to an implementation. FIG. 3a depicts the structure when the towed device is on the ground, waiting to be attached to an aircraft P. FIGS. 3b and 3c, which are respectively a perspective view and a longitudinal section view, depict the same structure when the towed device 1 is being towed by an aircraft P. The arrangement depicted by these FIGS. 3a to 3c is such that the support structure 30 and, therefore, the carried sensor or sensors (not shown in these figures) assume a stable and horizontal attitude.

According to this implementation, the support structure is substantially rectangular with the proximal portion 30p thereof having a substantially rectilinear leading edge. This leading edge is attached to a substantially cylindrical traction pole 20 the length of which is substantially equal to that of the leading edge. According to FIG. 3a, the fasteners 21 that anchor the traction pole to the support structure 30 advantageously include a single line that laces the two structures 20 and 30 together, the ends of the line being tied respectively to both ends 20i of the traction pole 20. The traction pole may be profiled, for instance with an ovoid cross section to allow it to move more easily through the air. The attitude-correcting structure 10 may comprise a correction pole 11 having a configuration similar to that of the traction pole. Such a correction pole 11 may be cylindrical and its cross section may be profiled to allow it to move through the air more easily. Each end 11i is attached to the two ends 20i of the traction pole 20 through first traction stays 12a of a same first length L12a. Each end 11i of the correction pole 11 is also attached to the central part 20c of the traction pole 20 through second traction stays 12b of a same second length L12b. The first length L12a is indicated schematically by a sign “/” marked on the stays 12a. Likewise, the second length L12b is indicated schematically by a sign “//” marked on the stays 12b.

The correction pole 11 is linked to the female attachment element (not depicted in FIGS. 3a, 3b and 3c) through a plurality of attachment stays. By way of example, in conjunction with FIGS. 3a to 3c, five attachment stays 13a, 13b, 13c, 13d and 13e are provided, having respective distal ends 13ad, 13bd, 13cd, 13dd and 13ed attached to the correction pole 11; in this example, the distal ends are distributed along the pole, namely from its ends 11i toward its central part 11c. The proximal ends 13ap, 13bp, 13cp, 13dp and 13ep of the attachment stays can be joined together at a point 14d and are attached together to the distal end 14d of an attachment cable 14 whose proximal end 14p carries the female attachment element. The individual lengths L13a, L13b, L13c, L13d and L13e of the attachment stays 13a, 13b, 13c, 13d and 13e are mutually determined so that the correction pole 11 is automatically positioned vertically and then kept vertical when the towed device is being towed by an aircraft, as indicated by FIGS. 3b and 3c. In order to favor vertical positioning of the correction pole, the latter may comprise a ballast weight. One of the ends 11i may thus be heavier than the second end. If the correction pole 11 is hollow, the ballast weight may also be movably mounted inside the pole so that it automatically positions itself near the lower end 11i . The attachment stays arranged in accordance with disclosed implementations allow significant reduction of the ballast weight.

Furthermore, the individual lengths L13a, L13b, L13c, L13d and L13e of the attachment stays are determined to provide a given relative elevation A30 of the longitudinal axis of the support structure 30 with respect to the distal end 14d of the attachment cable 14, as indicated in the lateral view depicted in FIG. 3c. It is thus possible to keep the support structure 30 in an air foil created by the relative wind generated by the movement of the towed device. Thus, the elevation of the support structure is well stabilized.

Specifically, if the lengths of the attachment stays are such that the stays are symmetric about the midline of the pole 11, the elevation A30 is zero. In contrast, as shown in FIG. 3c, if the lengths L13a, L13b, L13c, L13d and L13e are such that the stay 13a is the shortest and the stays 13b, 13c, 13d and 13e are of increasing lengths, then the elevation of the structure 30 is lower than that of the attachment cable 14. The relative elevation of the longitudinal axis of the support structure 30 can therefore be adjusted in relation to the distal end 14d of the attachment cable 14, while the pole 11 remains substantially vertical.

Bearing in mind the respective lengths L13a, L13b, L13c, L13d and L13e of the attachment stays and those L12a and L12b of the traction stays, under the traction of the aircraft P, the correction pole 11 stands up into a vertical position automatically and the traction pole positions itself in a horizontal position, also automatically, with an attitude having a given relative elevation A30 with respect to the attachment cable, therefore the towing cable and, as a result, the aircraft P.

Like the fasteners 21, the attachment stays and/or the traction stays may include distinct cords or cables. They may furthermore include a single attachment line 13 and/or a single traction line 12, these lines being linked to the correction pole and/or the traction pole 20 through openings made in the poles, the poles having a hollow tubular structures or even comprising protruding fastening points (or rings). The individual lengths L13a, L13b, L13c, L13d, L13e of the attachment stays 13a, 13b, 13c, 13d, 13e and/or the lengths L12a and L12b of the traction stays 12a and 12b may be accurately determined by knotting the lines 13 and 12 or by the use of travel-limiting elements positioned on the lines. According to the example described in conjunction with FIGS. 3a to 3c, the length of the traction pole is of the order of twenty meters. The correction pole may be shorter, for example of the order of four to six meters. All other dimensions may be adapted according to the size of the support structure 30 that is to be towed.

FIG. 4 illustrates a second implementation of a structure 10 for correcting the attitude of a towed device. FIG. 4 depicts a towed structure, in which the support structure 30 and, as a result, the carried sensor or sensors (which are not depicted in FIG. 4) have a stable and vertical attitude. According to this implementation, the support structure 30 is substantially rectangular and its proximal portion 30p has a substantially rectilinear leading edge. This leading edge includes a transverse sleeve into which is inserted a substantially cylindrical traction pole 20, the length of which is substantially equal to that of said leading edge. As an alternative, like in the example described in conjunction with FIG. 3a, the traction pole 20 could attach to the leading edge 30p through fasteners 21, advantageously including a single line “lacing” the two elements 20 and 30 together. The ends of the line are tied respectively to the ends 20i of the traction pole 20. The traction pole may be profiled, i.e. may have an ovoid cross section improving its aerodynamics.

The attitude-correcting structure 10 can include a correction pole lithe configuration of which is similar to that of the traction pole 20. It may be cylindrical and its cross section may be profiled to improve aerodynamics. The correction pole 11 is linked by means of a plurality of coplanar traction stays 12a, 12b, 12c, 12d, 12e, 12e′, 12d′, 12c, 12b′, 12a′ to the traction pole 20 through suitable openings formed in the sleeve 30p. The respective distal ends of the stays attach to the correction pole 11 and the respective proximal ends attach to the traction pole 20. The individual lengths of the traction stays and the respective points to which they attach on the poles 11 and 20 are axially symmetric about a midline M common to the poles. Thus, the lengths L12a, L12b, L12c, L12d and L12e of the traction stays 12a, 12b, 12c, 12d and 12e are respectively equal to the lengths L12a′, L12b′, L12c′, L12d′ and L12e′ of the traction stays 12a′, 12b′, 12c′, 12d′ and 12e′. According to a configuration example, the traction pole 20 and the correction pole 11 have respective lengths of twenty meters and five meters. The poles 20 and 11 are thus aligned and parallel.

Similarly to the implementation described in conjunction with FIGS. 3a, 3b and 3c, the correction pole 11 is linked to a female attachment element (not depicted in FIG. 4) through a plurality of attachment stays. By way of example, in conjunction with FIG. 4, five attachment stays 13a, 13b, 13c, 13d and 13e are provided, whose distal ends 13ad, 13bd, 13cd, 13dd and 13ed are attached along the correction pole 11 between the ends 11i thereof. The proximal ends 13ap, 13bp, 13cp, 13dp and 13ep of the attachment stays can be joined together at a point 14d and attach together to the distal end 14d of an attachment cable 14 whose proximal end 14p bears the female attachment element. The individual lengths L13a, L13b, L13c, L13d and L13e of the attachment stays 13a, 13b, 13c, 13d and 13e are mutually determined so that the correction pole 11 is automatically positioned vertically and then kept vertical when the towed device is being pulled by an aircraft P, as indicated in FIG. 4. Furthermore, the individual lengths L13a, L13b, L13c, L13d and L13e of the attachment stays are determined so as to define a given relative elevation A30 of the longitudinal axis of the support structure 30, namely the midline M, with respect to the distal end 14d of the attachment cable 14, as indicated in the lateral view depicted in FIG. 4.

Specifically, if the lengths of the attachment stays were determined for achieving a symmetry about the midline M of the pole 11, the elevation A30 would be zero. In contrast, as FIG. 4 shows, if the lengths L13a, L13b, L13c, L13d and L13e are such that the stay 13a is the shortest and the stays 13b, 13c, 13d and 13e are of increasing lengths, then the average elevation of the support structure 30, namely that of the midline M, is lower than that of the attachment cable 14. The relative elevation of the longitudinal axis of the support structure 30 can thus be adjusted in this manner with respect to the distal end 14d of the attachment cable 14, while keeping said pole 11 substantially vertical.

Bearing in mind the individual lengths L13a, L13b, L13c, L13d and L13e of the attachment stays and those L12a, L12b, L12c, L12d, L12e, L12e′, L12d′, L12c, L12b′, L12a′ of the traction stays, under the traction of the aircraft P, the correction pole 11 stands up into a vertical position automatically. The traction pole also positions itself automatically in a vertical position with an attitude having a given relative elevation A30 with respect to the attachment cable, and therefore the towing cable and, as a result, the aircraft P. As indicated by way of example in FIG. 4, an antenna 34 or, more generally, a measurement sensor, may be attached to the traction stays.

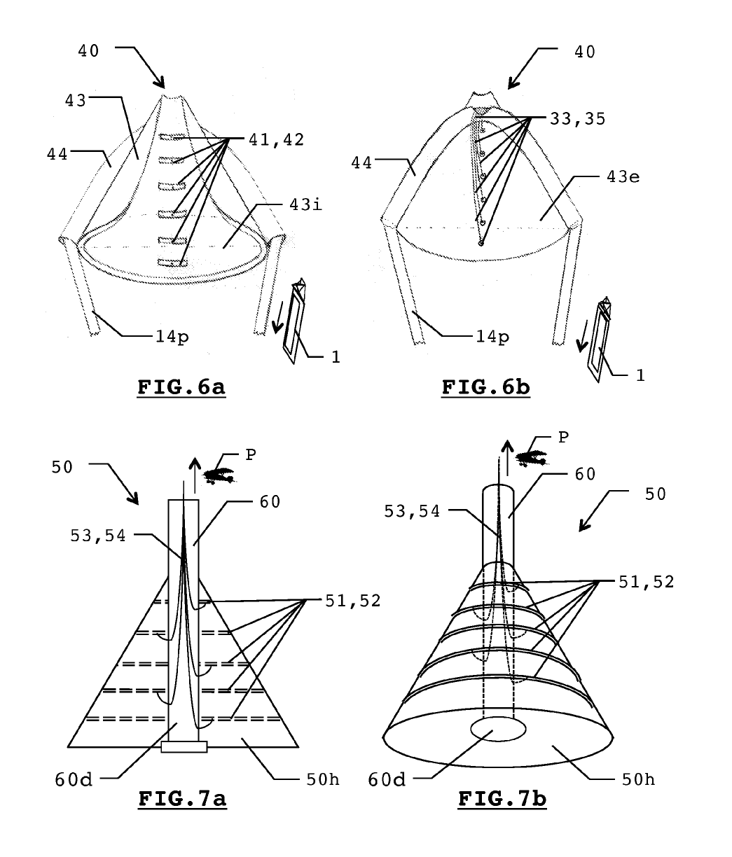

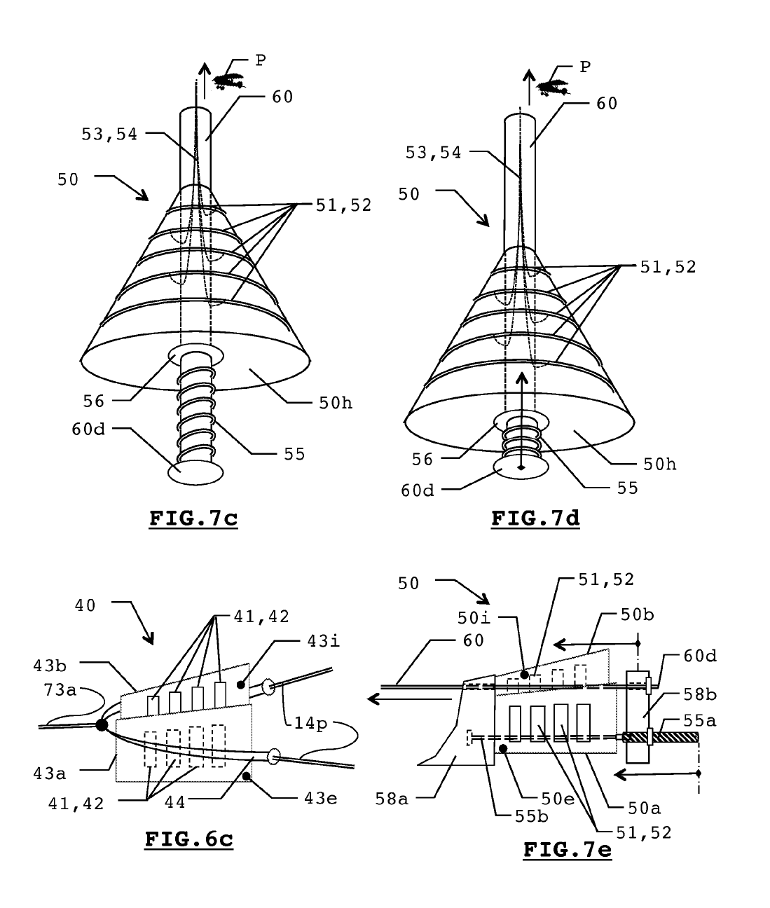

FIG. 5 schematically depicts a specific attachment area for a towed device 1 according to an implementation. For the sake of simplicity, only the proximal end 14p of the attachment cable 14 has been depicted. This proximal end includes a closed loop extending from a point 14f. The end or head of the loop 14p bears the attachment element 40. As shown by way of example and in detail in FIG. 6a, these elements may advantageously include a hollow conical structure 43, the external wall 43e of which can include a sleeve 44, designed to accept the end or head of the proximal end 14p of the attachment cable 14. As an alternative, this female attachment element may be configured according to a second example, illustrated by FIG. 6c, whereby a sleeve 44 receives a V-shaped member 43 having two lateral plates 43a and 43b, which can be trapezoidal. Such a female attachment element 40 is designed to accommodate a hook, for example the hook or spur 58a of a male attachment element 50 as described in conjunction with FIG. 7e, or, more generally, a male attachment element of a towing cable pulled by an aircraft. Such cooperation will be described in detail later on in conjunction with FIG. 8. The direction of attachment D is indicated by an arrow in FIG. 5. In order to carry out the attachment phase, the disclosed implementations provide for an attachment zone in which three posts 71, 72 and 73 are positioned in a triangle. The first two posts thus form the base of a virtual triangle. They are intended to spread apart the strands 14p of the closed loop at the proximal end of the attachment cable 14. The posts 71 and 72 thus comprise removable guides or fasteners for holding the strands 14p. The post 73, at the vertex of the triangle, receives a tension cable 73a the distal end of which is linked to the attachment element 40. Behind the base of the virtual triangle, the attachment cable 14 is spread out on the ground and possibly coiled. The support structure 30 (not depicted in FIG. 5) may be furled in order to reduce volume. The correction and traction poles rest on the ground. At the time of attachment, the strands 14p automatically detach themselves from the posts 71 and 72. Preferably fitted with removable fastener(s) at least at one of its ends, the tension cable 73a is detached from the post 73 and/or from the female attachment element 40. As an alternative, the post 73 may comprise a removable fastener so that it detaches itself from the tension cable 73a. The towed device 1 thus takes off, pulled by a towing cable. The attitude-correcting structure adopts its operating configuration and the support structure of the towed device is deployed.

A towed device according to an implementation may be used in numerous applications. For advertising purposes or to display targets, for example, it may be necessary to tow a passive support structure with a stable and determined attitude. For these same applications, and especially for collecting geophysical measurements, active elements, i.e. elements that may require an electrical power supply and communications channels, may be carried by the support structure or even by the attitude-correcting structure as indicated in FIG. 2. The active and communicating elements, for example displays, loudspeakers or sensors, may be provided with their own electrical power sources. As an alternative, they may cooperate with remote sources, for example photovoltaic cells, likewise carried by the support structure 30. The active elements may communicate with one another, or with the aircraft, using wireless protocols. Bearing in mind any electromagnetic radiation that may be emitted by an antenna 31 carried by the support structure, it is possible that such wireless protocols may be irrelevant. One or more communications and power supply buses may be provided to carry power, messages and measurements from the aircraft to the towed device and vice versa. It is thus possible to transmit requests from a computer carried onboard the aircraft P to active elements 31, 32 carried by the support structure 30. Reciprocally, such buses allow said computer to collect and then process measurements taken by the active elements. Running a bus along the support structure or even along some of the stays raises no technical difficulties. The electrical wires or conductors may be fixed by any element: stitching, bonding, braiding, etc. In contrast, bearing in mind the magnitude of the strains and mechanical forces resulting from a phase of attaching the towed device to an aircraft in flight through a towing cable, establishing an electrical connection between the aircraft and the towed device is a complex matter. The disclosed implementations overcome these technical difficulties.

In that respect, FIG. 6a, 6b or 6c illustrate a female attachment element 40 that provides both a physical, mechanical connection to a male attachment element such as that described later on by way of example with reference to FIGS. 7a to 7e, and an electrical connection. In this respect and according to a first implementation described in conjunction with FIGS. 6a and 6b, the internal wall 43i of a hollow conical structure 43 of the attachment element 40 is made from one or more dielectric materials. It can include a plurality of protruding electrical connectors 41, 42. These connectors may be positioned along a column from the base toward the vertex of the conical structure 43. As indicated in FIG. 6b, which is a view from beneath (and/or a cutaway view) of the element 40, each connector 41, 42 is connected to the distal end of an electrical connector or wire 33, 35, the group of wires forming an electrical communications bus. The electrical wires 33, 35 are then guided by the attachment cable 14. The cable may encircle the communications bus 33, 35. As an alternative, the attachment cable 14 may include a fibrous structure. The proximal end of the communications bus 33, 35 may therefore be interlaced with the fibers of the cable 14. It is possible for example to devote a first set of conductors 33 associated with connectors 41 to a downlink, i.e. a communication from a computer carried onboard the aircraft to an emitting antenna. This is then referred to as a downlink bus. Likewise, a second set of conductors 35 associated with connectors 42 may be dedicated to an uplink, i.e. a communication from a receiving antenna carried by the towed device to a computer carried onboard the aircraft. This is then referred to as an uplink bus or uplink communication bus.

FIGS. 7a and 7b illustrate a first implementation of a male attachment element 50 borne by a towing cable 60 for an aircraft. This male attachment element 50 is designed to mate with a female attachment element 40 of a towed device 1 according to an implementation as indicated by way of example in FIG. 8. The male attachment element 50 may include a stud 50h, which can have a conical shape, attached to the distal end 60d of the towing cable 60. Preferably, the distal end 60d of the cable 60 is attached to the base of the cone. The two elements may be crimped or fixed together by any means, so that the cone 50h is mounted firmly on the distal end 60d of the cable 60 and can withstand the attachment force followed by the traction force involved in pulling the towed device. In the event that the towed device can include active elements communicating with the aircraft, the towing cable 60, and therefore the stud 50h are designed to carry one or more communications buses 53 and/or 54. Such buses include one or more electrical conductors contained in the elements 60 and 50. As an alternative, the conductors 53 and/or 54 may be guided by the cable 60, the conductors simply being attached along the cable. Preferably, the towing cable can include a core in the form of a line, the purpose of which is to withstand the tensile force of traction, and a sheath surrounding both the core and the electrical conductors. An uplink bus 53 and/or a downlink bus can thus be carried reliably. Said buses 53 and 54 are respectively connected to the communications buses 33 and 35 described in conjunction with FIG. 6b by the female attachment element 40 and male attachment element 50. To that end, the stud 50h can include electrical connectors 51 and/or 52 protruding from the dielectric external wall of the stud 50h. The electrical connectors embody the distal end of the communications bus or buses carried by the towing cable. Preferably, the electrical connectors 51 and 52 include separate concentric rings. Such an arrangement ensures a reliable cooperation between the connectors 41 and 42 of the female attachment element and the connectors 51 and 52 of the stud 50h, irrespective of the orientation of the conical stud 50h as it is inserted within the female attachment element 40, as indicated in FIG. 8.

Consider a towed structure like the one described in conjunction with FIG. 1a or 1b. As indicated by way of example in FIG. 5, during a phase of attaching the towed device 1 to the aircraft P, the ground speed of the aircraft P is close to 150 km/h. Although in general the aircraft P pulls up sharply in order to reduce the ground speed, this ground speed is still in excess of 100 km/h. When the attachment cable 14 tightens after the male attachment element 50, belonging to the towing cable 60, enters the female attachment element 40, belonging to the towed device 1, the mechanical stress is intense and is transmitted to the entire towed structure with the risk of causing mechanical failure. This phenomenon is exacerbated by the unusual dimensions of a towed device designed in particular to collect geophysical measurements, such dimensions reaching several hundreds or even thousands of square meters.

Implementations disclosed herein include a male attachment element that have an attachment damper, the purpose of which is to accompany the attachment motion while damping it. The mechanical components or parts of the towed structure, namely, non-exhaustively, the cables, the stays, the poles, are thus spared. As an alternative or in addition, the attachment cable 14 of the towed device may comprise an attachment damper.

FIGS. 7c and 7d describe a first exemplary implementation of a male attachment element similar to that described previously in conjunction with FIGS. 7a and 7b. The male attachment element 50 may be in the form of a conical stud 50h. The cone can include a longitudinal internal passage opening at the vertex and at the base of the cone 50h. The cone may thus be mounted with the ability to move along the towing cable 60. The distal end 60d of the towing cable may be linked to the base of the cone 50h through an axial coil spring 55 or any other element that performs an equivalent function. The spring 55 is constrained between the distal end of the cable 60, which is widened or has an end stop, and a ring 56 positioned against the conical base. Following attachment, when the cone 50h mates with a female attachment element 40 of the towed device, the spring 55 compresses, thus absorbing some of the attachment load or the tensile force from pulling the towed device. In the event that the towed device can include active elements communicating with the towing aircraft, the towing cable 60, and therefore the stud 50h are designed to carry one or more communications buses 53, 54 connected to concentric conducting connectors 51 and 52, as previously described in conjunction with FIGS. 7a and 7b.

A second exemplary implementation is provided herein for a male attachment element 50 borne by the distal end 60d of a towing cable, comprising an attachment damper.

Such an arrangement is described in conjunction with FIG. 7e. The male attachment element 50 can include a hook or a spur 58a mounted with the ability to move along the distal portion of the towing cable 60. The distal end 60d of the cable 60 is fixed to, or built into a heel 58b. The hook 58a is attached to, or can include a stud 50h that has two plates 50a and 50b, which can be trapezoidal, forming a V whose vertex is turned away from the distal end 60d of the cable 60 and links to the hook 58a or forms part thereof. The stud 50h including the plates 50a and 50b is thus hollow, allowing the heel 58b to slide within it under the traction of the towing cable 60, until the heel 58b comes into contact with the internal vertex of the stud 50h. In order to slow the travel of the heel 58b and thus absorb the attachment force of a towed device when the male attachment element 50 mates with the attachment element 40 of the towed device, the hook 58a is linked to the heel 58b through a pneumatic or hydraulic actuator. The cylinder 55a thereof can be attached to the heel 58b. The piston 55b of the actuator is then attached to the hook 58a. As the heel 58b moves toward the hook 58a, the piston compresses a gas or a fluid contained in the cylinder 55a. In an implementation, this cylinder is filled with water, enough to provide the desired absorption effort. The cylinder of the actuator may comprise one or more small openings or valves so that the compressed water is expelled during the travel of the piston 55b in the cylinder 55a. The water may be replaced by any other fluid. Water does, however, have the advantage of not presenting any risk of contamination as it is expelled. At the end of the travel, the chamber of the cylinder 55a is empty, thus reducing the weight of the attachment element 50. The cylinder 55a will be refilled for a future attachment of a towed device.

Similarly to the attachment element 50 described earlier in conjunction with FIGS. 6a to 6d, the element 50 described in conjunction with FIG. 7e may further comprise electrical connectors 51 and 52, forming the distal end of communications buses running through the towing cable. These connectors may be positioned on the external walls 50e of the plates 50a and 50b. In this case the external walls 50e can be a dielectric material.

In order to cooperate with such a male attachment element 50 described in conjunction with FIG. 7e, the disclosed implementations provide for a second implementation of a female attachment element 40, for example the element 40 described in conjunction with FIG. 6c. The female attachment element 40 is similar overall to those described in conjunction with FIGS. 6a and 6b. However, they do differ by the configuration of the member 43. This member is configured substantially similarly to the member comprising the plates 50a and 50b of the element 50 described in FIG. 7e. Two plates 43a and 43b, or at least the exterior walls 43e thereof are attached to a sleeve 44. The sleeve is attached to the proximal end 14p of the traction cable 14. The V thus created by the plates 43a and 43b, the vertex of which may also be attached to the sleeve 44, is designed to receive the hook 58a, followed by the plates 50a and 50b of the male attachment element 50. The sleeve 44 and the member 43 may be integral or, as an alternative, they may be attached through any means, for instance by stitching, bonding, welding. If the attachment element 40 and 50 should also ensure an electrical connection, the internal walls 43i of the plates 43a and 43b may comprise electrical connectors that have respective contact pads for contacting the connectors 51, 52 of the attachment element 50 described earlier. The action of the heel 58b within the plates 50a and 50b causes the distal parts of the plates to part, in turn causing a contact force against the electrical connectors 42, 42 of the female attachment element 40. The attachment cable 14, the proximal end 14p of which is attached to the sleeve 44, in turn applies a force that causes the distal ends of the plates 43a and 43b to move closer together. This then ensures an electrical connection between the electrical connectors of the elements 40 and 50.

The traction of the towed device by the aircraft through the towing cable thus holds the attachment element 50 firmly within the female attachment element 40. Moreover, the attachment elements 40 and 50 may be provided with means for locking their mutual cooperation after the towed device has been attached.

In addition, the ability of the female attachment element 40 and the male attachment element 50 to achieve mechanical and/or electrical connections as exemplified in conjunction with FIGS. 6a, 6b, 6c, 7a and 7b may be put to use for towing a towed device by an aircraft even when the towed device does not have an attitude-correcting structure. The same is true for the attachment damping capability of a male attachment element, exemplified in conjunction with FIGS. 7c, 7d and 7e, of a towing cable intended to tow a passive towed device, namely one that does not require electrical connections and/or that does not have an attitude-correcting structure.

A towed structure according to an implementation thus can include an aircraft P, a towing cable 60 and a towed device 1, the aircraft pulling the towed device through the towing cable. Such a towed structure has been described through an example application related to the field of geophysical mapping. The dimensions of the support structure of a towed device according to the disclosed implementations achieve an airborne surface area, to date unparalleled, for carrying sensors that make it possible, during one and the same acquisition flight, to take electromagnetic readings of a subsoil in the frequency domain (using FDEM or frequency-domain electromagnetic induction) by measuring the amplitude and phase of an induced electromagnetic field and by measuring the decay time for induced electromagnetic pulses (using TDEM or time-domain electromagnetic induction). The depth to which the formations of a subsoil are inspected is linked to the dimensions of the carried emitting and receiving antennas. The implementations disclosed herein thus make it possible to prospect with accuracy and relevance in extremely contorted reliefs, such as in the mountains.

However, a towed device according to the disclosed implementations may be passive, namely may not require any electrical connection between the towing aircraft P and the towed device 1. In an active configuration, namely a configuration in which the towed device 1 requires electrical communication with a computer carried onboard the aircraft P, a towed structure according to the disclosed implementations may be used in all other applications, such as in geomatics, aerial advertising or airborne monitoring.

The aircraft may be a light airplane.

The towed structure could as an alternative comprise a helicopter or any other flying entity capable of pulling a towed device.

1. An airborne geophysical prospection device comprising:
a support structure having a surface area of several hundred square meters; and
an electromagnetic antenna disposed on the support structure, the electromagnetic antenna having a surface area of several hundred square meters, the electromagnetic antenna including one or more loops disposed on the support structure,
the support structure being configured to be towed behind an aircraft with a towing cable, and
the support structure being supple, deployable under traction and substantially planar after deployment.

2. The airborne geophysical prospection device of claim 1, wherein the support structure has a length between forty and sixty meters and/or a width between fifteen and twenty-five meters.

3. The airborne geophysical prospection device of claim 1, further comprising:
a traction pole;
means for fastening the support structure to the traction pole;
an attachment element for attachment to the towing cable; and
an attitude-correcting structure including:
an attitude-correcting pole connected to the attachment element; and
traction stays connecting the attitude-correcting pole to the traction pole.

4. The airborne geophysical prospection device of claim 3, wherein the attitude-correcting structure is configured to confer a horizontal attitude to the traction pole and the support structure and includes traction stays respectively connecting a first end of the attitude-correcting pole to two opposite ends of the traction pole, and a second end of the attitude-correcting pole to the two opposite ends of the traction pole.

5. The airborne geophysical prospection device of claim 4, wherein the attitude-correcting structure further includes additional traction stays, respectively connecting the first end of the attitude-correcting pole to a central portion of the traction pole, and the second end of the attitude-correcting pole to the central portion of the traction pole.

6. The airborne geophysical prospection device of claim 3, further comprising attachment stays for connecting the attitude-correcting pole to the attachment element.

7. The airborne geophysical prospection device of claim 6, wherein the attachment stays have individual different lengths with respect to a midline of the attitude-correcting pole, such that the attitude-correcting pole is automatically positioned and maintained vertically at an elevation of the midline below that of the attachment element when the airborne geophysical prospection device is towed.

8. The airborne geophysical prospection device of claim 3, wherein the attitude-correcting pole includes a ballast to ensure or favor vertical positioning of the attitude-correcting pole.

9. The airborne geophysical prospection device of claim 3, further comprising electrical connectors within the attachment element.

10. The airborne geophysical prospection device of claim 1, wherein the support structure includes a micro-perforated aerodynamic damping fabric.

11. The airborne geophysical prospection device of claim 1, wherein the support structure includes a tail damping element having a micro-perforated structure.

12. The airborne geophysical prospection device of claim 1, wherein the support structure has, disposed thereon, one or more sensors or probes.

13. The airborne geophysical prospection device of claim 1, wherein the support structure has, disposed thereon, an antenna configured to receive electromagnetic signals.

14. A method of airborne geophysical prospection comprising:
providing a supple support structure that is deployable under traction and substantially planar when deployed, the supple support structure having a surface area of several hundred square meters; and
disposing, on the supple support structure, an electromagnetic antenna having a surface area of several hundred square meters, the electromagnetic antenna including one or more loops,
the supple support structure and the electromagnetic antenna being configured to be towed behind an aircraft with a towing cable.

15. The method of claim 14, wherein the support structure has a length between forty and sixty meters and/or a width between fifteen and twenty-five meters.

16. The method of claim 14, further comprising providing:
a traction pole;
means for fastening the support structure to the traction pole;
an attachment element for attachment to the towing cable; and
an attitude-correcting structure including:
an attitude-correcting pole connected to the attachment element; and
traction stays connecting the attitude-correcting pole to the traction pole.

17. The method of claim 16, further comprising:
configuring the attitude-correcting structure to confer a horizontal attitude to the traction pole and the supple support structure; and
providing traction stays respectively connecting a first end of the attitude-correcting pole to two opposite ends of the traction pole, and a second end of the attitude-correcting pole to the two opposite ends of the traction pole.

18. The method of claim 17, further comprising providing, in the attitude-correcting structure, additional traction stays respectively connecting the first end of the attitude-correcting pole to a central portion of the traction pole, and the second end of the attitude-correcting pole to the central portion of the traction pole.

19. The method of claim 16, further comprising providing attachment stays configured to connect the attitude-correcting pole to the attachment element.

20. The method of claim 19, wherein the attachment stays have individual different lengths with respect to a midline of the attitude-correcting pole, such that the attitude-correcting pole is automatically positioned and maintained vertically at an elevation of the midline below that of the attachment element when supple support structure and the electromagnetic antenna are towed.

21. The method of claim 16, further comprising providing a ballast in the attitude-correcting pole to ensure or favor vertical positioning of the attitude-correcting pole.

22. The method of claim 16, further comprising providing electrical connectors within the attachment element.

23. The method of claim 14, wherein the supple support structure includes a micro-perforated aerodynamic damping fabric.

24. The method of claim 14, further comprising providing, at a tail of the support structure, a damping element having a micro-perforated structure.

25. The method of claim 14, further comprising providing one or more sensors or probes disposed on the support structure.

26. The method of claim 14, further comprising disposing, on the supple support structure, an antenna configured to receive electromagnetic signals.
